(19) United States
(12) Patent Application Publication
(10) Pub. No.: US 2019/0201935 A1
(43) Pub. Date: Jul. 4, 2019

(54) IMPULSE MECHANISM FOR VIBRATING SCREEN

(71) Applicant: Johnson Crushers International, Inc., Eugene, OR (US)

(72) Inventors: Gary Heeszel, Eugene, OR (US); Wills Boothe, Veneta, OR (US); Richard Raley, Cottage Grove, OR (US)

(73) Assignee: Johnson Crushers International, Inc., Eugene, OR (US)

(21) Appl. No.: 16/221,961

(22) Filed: Dec. 17, 2018

Related U.S. Application Data
(60) Provisional application No. 62/611,652, filed on Dec. 29, 2017.

(51) Int. Cl. B06B 1/16; B07B 1/28

(52) U.S. Cl. CPC B06B 1/166; B07B 1/284

(57) ABSTRACT

An impulse mechanism for use with a vibratory screen includes a rotatable shaft having exposed opposing ends terminating outside the vibratory screen, a stationary spindle surrounding the opposing ends of the shaft, and vibration generators located on each of the opposing ends of the shaft that generate vibrations when the shaft is rotated. Each vibration generator includes a bearing housing that rotates with the shaft, an exposed mass component mounted to the bearing housing is accessible from outside the bearing housing and rotates about the shaft to generate vibrations, and a bearing assembly located within the bearing housing transmits vibrations from the rotating mass component to the vibratory screen assembly.

### CROSS-REFERENCE TO RELATED APPLICATIONS

This application claims the benefit of U.S. Provisional Patent Application No. 62/611,652, filed on Dec. 29, 2017 and entitled IMPROVED IMPULSE MECHANISM FOR VIBRATING SCREEN, which is incorporated herein by reference in its entirety.

### FIELD OF THE INVENTION

This invention relates to a vibratory screen assembly used for classifying materials by particle size. More particularly, the invention relates to an advantageous configuration of an impulse mechanism that provides a relatively large ratio between induced vibration and mass of the impulse mechanism. Preferred embodiments of the invention include means for trapping contaminants that are in the lubricant and means for circulating the lubricant in order to promote heat rejection. Another embodiment of the invention allows for the use of grease as a lubricant.

### BACKGROUND OF THE INVENTION

Vibratory screens are used to classify and separate material into two or more different particle sizes. Screens are typically comprised of a pair of side plates disposed parallel to each other and connected by one or more screen decks. The side plates and screen decks are supported by compliant members which are commonly metal or elastomer springs. The entire assembly that is supported by the compliant members is known as the screen assembly.

Vibration of a screen assembly is generally induced by one or more mass components that are attached to the screen structure and adapted to rotate about an axis fixed with respect to the screen structure. A mass component is the sum of the masses that are rotatable about a particular axis fixed with respect to a screen structure. A simplified screen impulse mechanism comprises a single rotating mass component which has an axis of rotation intersecting the center of gravity of a uniformly and compliantly supported screen structure. It is understood that variations in the location of the mass component's axis of rotation, and variations in the configuration of the structural support as well as variations in the number of mass components and the phase angles of the various rotating masses will lead to variation in the net response of a vibratory screen assembly. The eccentric radius of a mass component of a simplified screen impulse mechanism is the distance between the center of mass of the mass component and the axis of its rotation. For a given speed of rotation, the magnitude of screen vibration of a screen assembly equipped with a simplified screen impulse mechanism is proportional to the product of the mass of the mass component and its eccentric radius and is inversely proportional to the mass of the screen assembly (including the mass of the mass component). This relationship reveals that there is a benefit to increasing the eccentric radius as it will reduce the mass of the mass component required to produce a desired magnitude of vibration, thereby reducing the total mass of the screen assembly.

A mass component, used to vibrate a screen, is typically mounted to the screen assembly by means of a rotary bearing. The type and configuration of rotary bearings can vary; however, the type typically found in vibrating screen assemblies can be characterized by an inner and outer race that are allowed to rotate independently with respect to each other with a minimal amount of friction, and the ability to support a radial load. In vibrating screen assemblies, one of the races is generally held substantially fixed with respect to the screen structure and the other race is made to rotate in order to rotate the mass component which, as aforementioned, induces vibration.

Screen impulse mechanisms can be differentiated into two distinct types based on which of the bearing races are made to rotate. With reference to FIG. 1, Rotating Inner Race (“RIR”) assemblies, which have a fixed outer race 1 and a rotating inner race 2, are the oldest type and were used on the first vibrating screen assemblies. They are typically comprised of an eccentrically weighted shaft which rotates with the inner race of the bearing. A lubrication housing may surround the bearing and be sealed in a variety of ways. The RIR configuration is applied extensively to vibrating screens of all types and is the primary configuration for incline screens. RIR configurations typically have a heavy duty shaft which may be eccentrically weighted by virtue of its construction or by virtue of the eccentric attachment of mass components. In either event, the center of mass of an eccentrically weighted shaft does not coincide with the axis of rotation. Such a shaft must be designed to withstand the torsion applied to it as well as the bending moment from the rotation of the eccentric mass. The eccentric radius of these assemblies (especially ones with a significant portion of the vibration induced by an eccentric shaft) tends to be small and the shaft tends to be heavy.

Referring to FIG. 2, Rotating Outer Race (“ROR”) assemblies have a fixed inner race 3 and a rotating outer race 4 and are somewhat newer (although they may be traced back as far as U.S. Pat. No. 2,267,143). The most common ROR configuration used in vibrating screen assemblies is similar to that described in U.S. Pat. No. 4,170,549, the disclosure of which is incorporated herein by reference. One end of an impulse mechanism that is similar to that described in U.S. Pat. No. 4,170,549 is shown in FIG. 3. As shown therein, impulse mechanism 5 utilizes a relatively light-weight shaft 6 which is coupled to a hub 7 and, in turn, coupled to an eccentric bearing housing 8 which has additional eccentric weights 13 bolted to it. The eccentric bearing housing is rotationally coupled to the outer race of a bearing 9, the inner race of which is coupled to a fixed spindle 10 which is mounted to the screen side plate 16 and shaft tube 11 and has a hollowed center to accommodate shaft 6. The configuration of the ROR assembly facilitates the eccentrically mounted mass component being located outside of the diameter of the outer bearing race and yields a configuration that may have a large eccentric radius and a correspondingly small eccentrically mounted mass component for a given induced vibration.

The prior art impulse mechanism 5 shown in FIG. 3 has three eccentrically mounted mass components which are rotatably coupled by means of three gears 12. Consequently, the two outer mass components rotate in the same direction and the middle one rotates in the opposite direction. The gears 12 are mounted within the eccentric bearing housing and ensure that the phase between the mass components is consistent. A large lubrication housing 14 surrounds the three eccentric mass components and the gear assembly. This type of lubrication housing is typical of ROR configurations known to those having ordinary skill in the art to which the invention relates. The ROR bearing and the gear assembly both require lubrication and, in this configuration, receive said lubrication from oil 15 in the housing that is splashed, misted or otherwise agitated onto the various components.

Lubrication systems associated with prior art ROR impulse mechanisms can be generally characterized by a single lubrication housing which fully encompasses the meshing gears of the gear assembly and the eccentrically mounted mass components of the impulse mechanism. The lubrication system of prior art ROR impulse mechanisms can further be characterized by the exclusion of grease as the lubricant since splashing or misting is the mode for lubricating the bearings and gears.

One limitation of prior art ROR mechanisms is that the eccentrically mounted mass components are not accessible without opening the lubrication housing. Another limitation of these prior art mechanisms is that the oil level within the housing must be considered when designing the inclination angle of the screen assembly, which may reduce the available angles that a particular screen assembly can operate. Another limitation of these mechanisms is that a large quantity of oil is typically required, which makes oil changes costly. A final limitation of prior art ROR mechanisms, as mentioned above, is that grease is not an available lubrication option.

It would be advantageous if an ROR impulse mechanism could be configured that had a more compact lubrication housing which does not enclose the eccentrically mounted mass components (allowing better access to those mass components) and does not require as much lubricating oil. It would also be advantageous if an ROR mechanism could be configured that had a means for separating contaminant particles from the lubricating oil. It would also be advantageous if an ROR mechanism could be provided with a means for circulating the lubricating fluid in a way that can help to reject heat produced during operation of the impulse mechanism so as to reduce the overall operating temperature of the mechanism. It would also be advantageous if an ROR impulse mechanism could be provided that could operate with grease as the lubricant.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY OF THE INVENTION

The above and other needs are met by an improved ROR impulse mechanism that has a compact lubrication housing which does not enclose eccentrically mounted mass components. Preferred embodiments of the invention include means for trapping contaminants that are in the lubricant and means for circulating lubricating oil in order to aid in heat rejection. Another embodiment of the invention allows for the use of grease as a lubricant.

The present invention is superior to prior art RIR impulse mechanisms because it has a larger eccentric radius made possible by a lighter shaft which is one of the numerous benefits of an ROR configuration. The present invention is also advantageous to prior art RIR impulse mechanism assemblies because it allows for larger bearings to be used without necessarily increasing the shaft diameter.

Preferred embodiments of the invention are also superior to prior art ROR impulse mechanisms because they have lubrication systems that are compact and specific to an individual impulse mechanism. This means that a screen assembly can be equipped with any number of impulse mechanisms without changing the lubrication system. The lubrication system is also insensitive to the angle of inclination of the screen. This means that a screen assembly equipped with the present invention can, without lubrication consideration, operate at a wide variety of angles. The present invention is also advantageous to prior art ROR assemblies because it may provide adequate lubrication and heat transfer with less oil than would be required with prior art lubrication systems.

Preferred embodiments of the present invention also provide a novel approach for trapping impurities and contaminants in the lubricant by harnessing the centrifugal force created by the impulse mechanism. Preferred embodiments of the present invention also provide a novel lubricant circulation system which harnesses the rotational energy of the impulse mechanism to circulate oil providing heat rejection to the system. These advantages will become apparent to those skilled in the art to which the invention relates and will be more fully appreciated upon reference to the following detailed description and the accompanying drawings.

### BRIEF DESCRIPTION OF THE DRAWINGS

The presently preferred embodiments of the invention are illustrated in the accompanying drawings, in which like reference numerals represent like parts throughout, and in which:

FIG. 1 depicts a prior art rotary bearing having a fixed outer race and rotating inner race;

FIG. 2 depicts a prior art rotary bearing that has a rotating outer race and fixed inner race;

FIG. 3 depicts an isometric cutaway view of an end of a single shaft in a prior art three-shaft impulse mechanism;

FIG. 4 depicts a screen assembly having a single impulse mechanism according to an embodiment of the present invention;

FIG. 5 is a sectional view depicting the impulse mechanism of FIG. 4 and taken through a vertical plane defined by a shaft axis of rotation;

FIG. 6 is a sectional view taken along line A-A of FIG. 5, with items 38, 39 and 40 removed for clarity;

FIG. 7 is a detail view taken from box B of FIG. 5;

FIG. 8 is an isometric, cut away view of the impulse mechanism of FIG. 4;

FIG. 9 is a detail view taken from the same orientation as FIG. 7 of an impulse mechanism 80 according to an alternative embodiment of the present invention;

FIG. 10 s a detail view taken from the same orientation as FIG. 7 of an impulse mechanism 81 according to an alternative embodiment of the present invention;

FIG. 11 s a detail view taken from the same orientation as FIG. 7 of an impulse mechanism 82 according to an alternative embodiment of the present invention;

FIG. 12 s a detail view taken from the same orientation as FIG. 7 of an impulse mechanism 83 according to an alternative embodiment of the present invention; and

FIG. 13 s a detail view taken from the same orientation as FIG. 7 of an impulse mechanism 84 according to an alternative embodiment of the present invention.

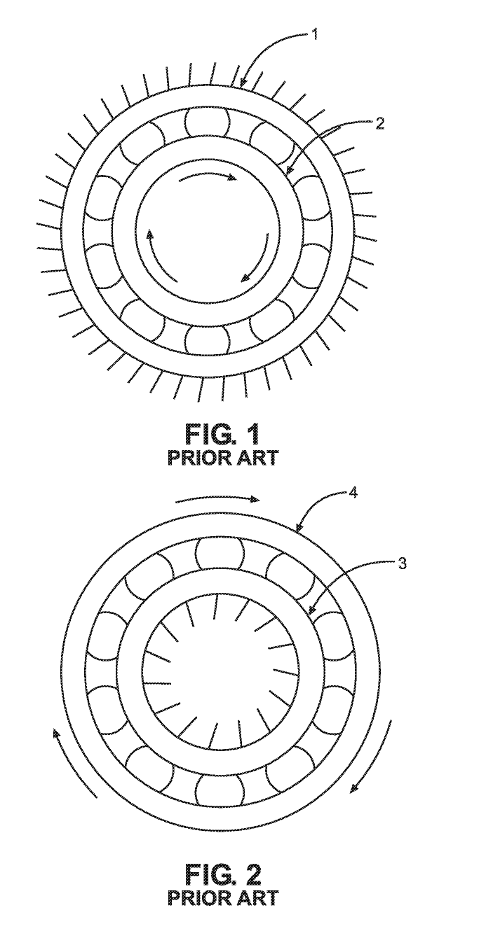

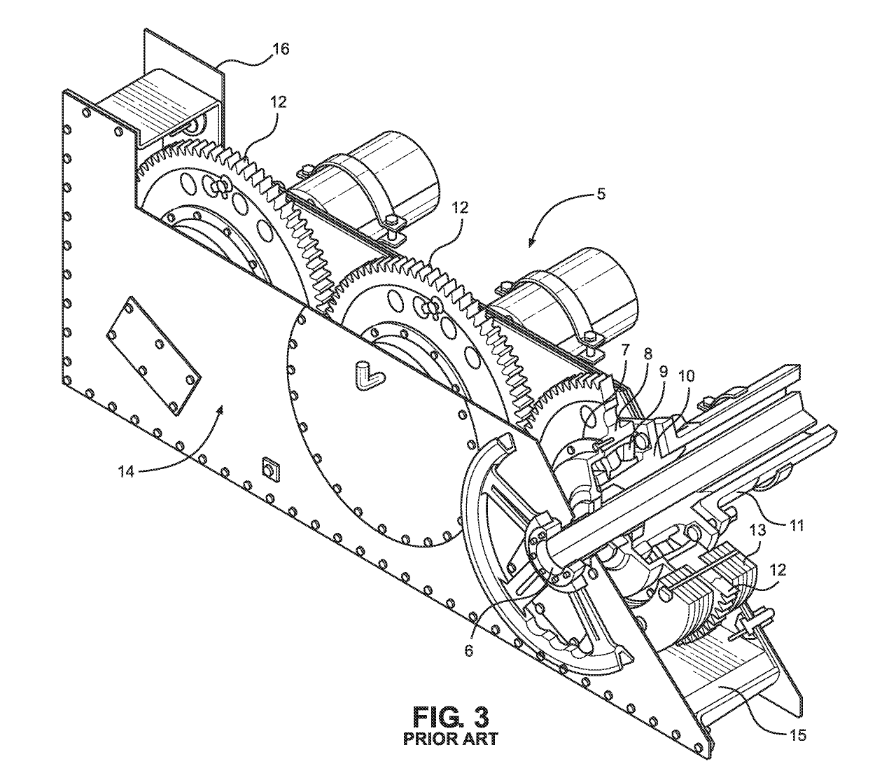

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

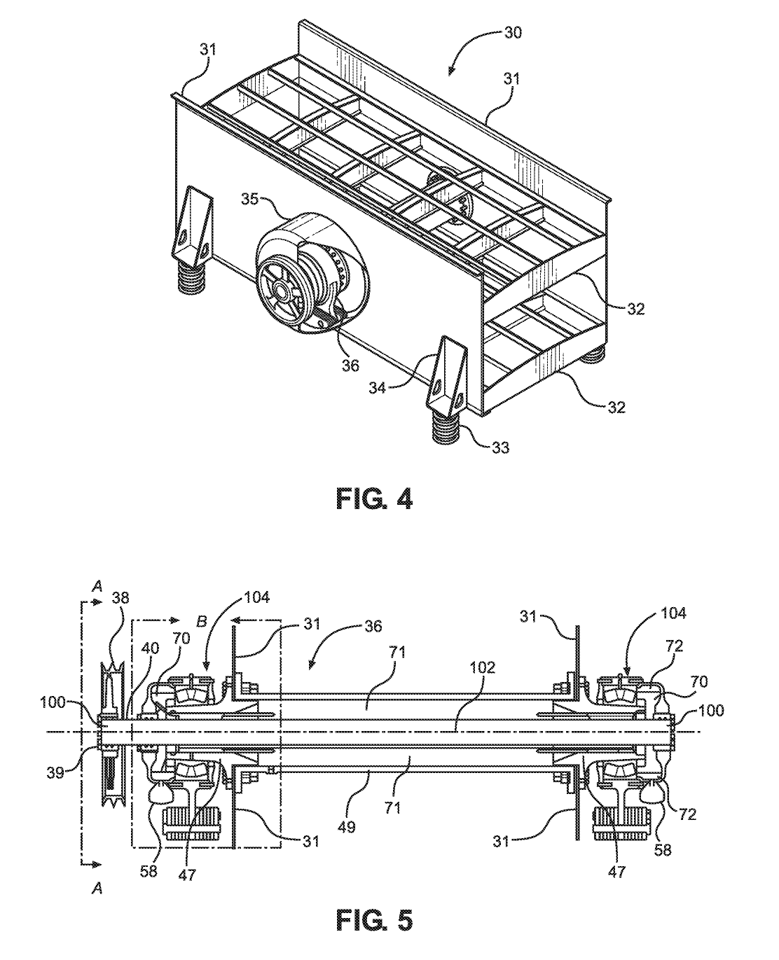

Referring now to the drawings and, more particularly to FIG. 4, there is provided an impulse mechanism 36 that is mounted in a screen assembly 30. The screen assembly 30 is shown for reference and its configuration is not material to the present invention. Screen assembly 30 is equipped with a pair of spaced apart side plates 31 which are disposed parallel to each other and attached to a plurality of spring brackets 34 which are supported by compliant members 33. The side plates 31 are shown as being comprised of a single thickness of plate; however, they may be comprised of a plurality of plates which are overlaid, as is known to those having ordinary skill in the appropriate art. The side plates 31 are also attached to screen decks 32, the orientations of which are substantially perpendicular to side plates 31. A cutaway view of a guard 35 is shown near the end of preferred embodiment impulse mechanism 36 which can be seen in more detail in FIGS. 5-8.

In general and as detailed below, the impulse mechanism includes a rotatable shaft 40 having exposed opposing ends 100 that terminate outside the vibratory screen adjacent the outside surface of side plates 31. Shaft 40 is configured to rotate about an axis of rotation 102 that runs through each of the opposing ends 100. A stationary spindle 47 surrounds each of the opposing ends of the shaft 40. Vibration generators 104 are located on each of the opposing ends of the shaft 40 and generate vibrations when the shaft is rotated. Each vibration generator 104 includes an eccentric bearing housing 43 that rotates with the shaft 40. An exposed eccentric mass component 59 (that may be a single mass or a number of discrete mass plates joined together by a fastener, such as bolt 60) is mounted to the bearing housing 43 and is accessible from outside the bearing housing 43. The mass component 59 rotates about the shaft 40 to generate vibrations. A bearing assembly 106 is located within the bearing housing 43 and transmits vibrations generated by the rotating mass component 59 to the vibratory screen assembly 30.

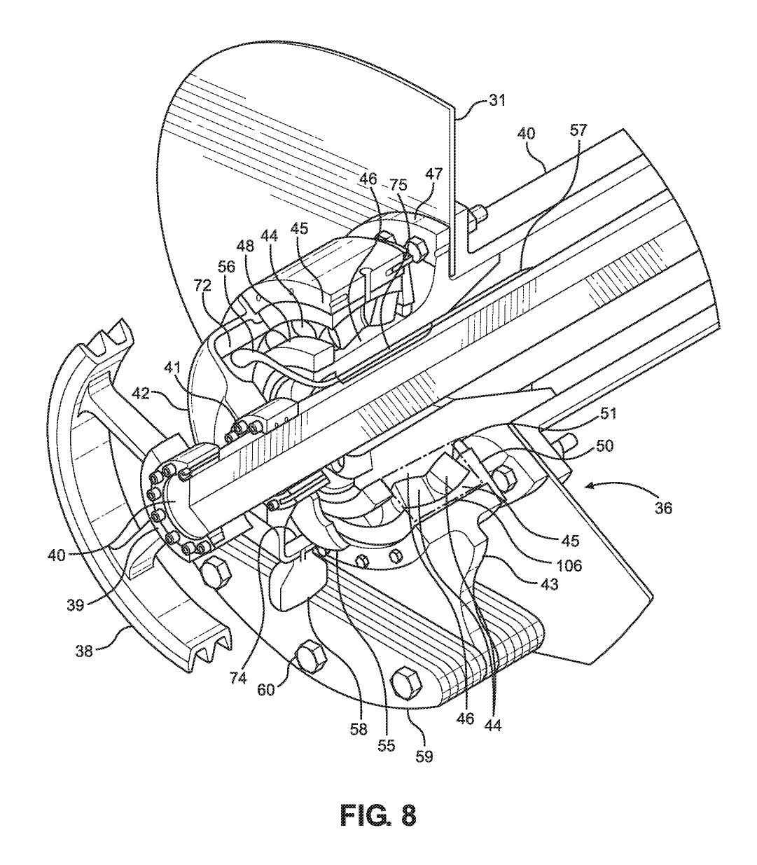

Rotational energy is applied to sheave 38 (shown in FIG. 5) which is coupled to shaft 40 by means of keyless bushing 39. The shaft 40 is coupled to hub 42 (shown in FIG. 7 and FIG. 8) by means of keyless bushing 41. The hub 42 is also fastened to eccentric bearing housing 43. The bearing assembly 106 is located within the bearing housing 43 and includes a bearing inner race 46, a bearing outer race 45, and a plurality of rolling elements 44 disposed between the inner and outer races. The eccentric housing 43 is also rotationally coupled to a seal housing 50 which contains, in the preferred embodiment, a lip seal 51. In this embodiment of the invention, lip seal 51 interacts with spindle 47 in order to contain the lubricant and exclude any contaminants from entering housing 43. The type of seal is specified only to provide clarity of the preferred embodiment however, a variety of seal designs, known to those skilled in the art, could be used to enclose the bearing housing.

Bearing inner race 46 is rotationally coupled to the spindle 47 and held fast by means of nut 48. A conventional lock washer (not shown) may also be used between nut 48 and spindle 47. Spindle 47 is bolted to shaft tube 49 and these two members sandwich side plate 31. The spindle may fit tightly into the shaft tube in order to increase the rigidity of the connection between the two members.

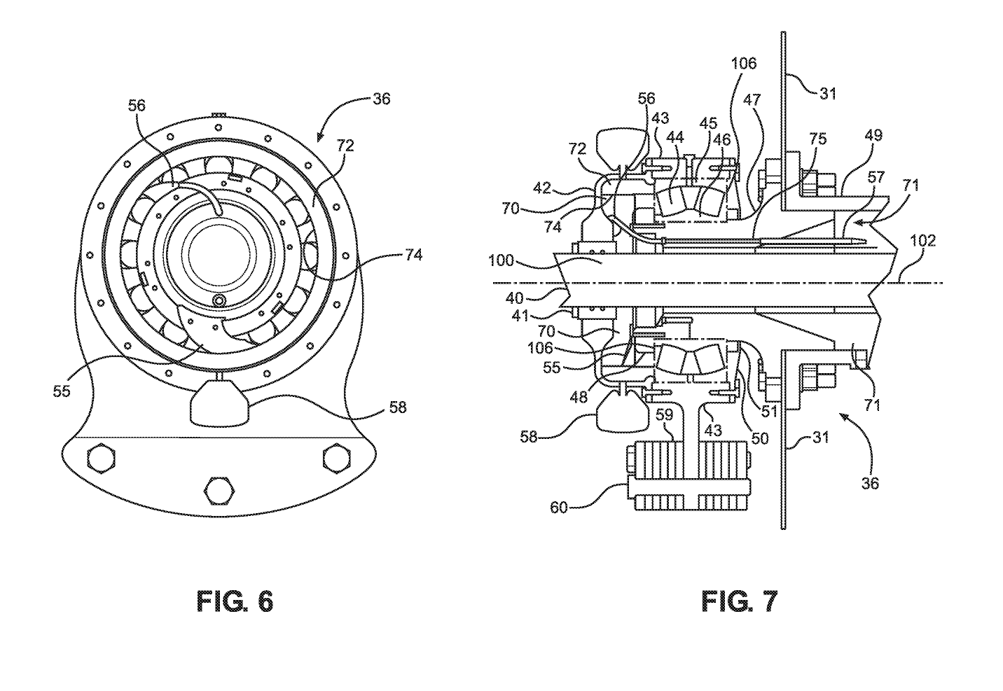

The lubrication system (best seen in FIG. 5 and FIG. 7) of a preferred embodiment of the invention consists of three chambers which contain lubricating oil. The first two chambers are called bearing chambers 70 and are defined, at least in part, by hub 42 and eccentric bearing housing 43. There are two bearing chambers 70 in each impulse mechanism 36; however, only one will be described in detail since they are substantially similar. During operation of the impulse mechanism 36, a thin wall of lubricating oil 72 is held against the radial wall of bearing chamber 70 by centrifugal force and defines a free surface 74 (shown in FIGS. 6-8). A “free surface” in this case is the theoretical radial boundary between lubricant 72 and air that is created when the impulse mechanism 36 is rotating at its normal operating speed. The radial distance between free surface 74 and the axis of rotation 102 of the impulse mechanism 36 is assumed, for the purpose of describing this embodiment of the invention, to be substantially constant and defined by the quantity of oil 72 in bearing chamber 70 and the geometry of the bearing chamber. Said another way, it is assumed that the only force acting on the lubricant 72 is the centrifugal force resulting from the rotation of the impulse mechanism 36. Any impurities in the lubricant that are denser than the oil 72 are forced to the radial wall of the bearing chamber 70 and will tend to travel to one or more contamination settling chamber(s) 58. It should be noted that contaminants contained in the bearing chamber 70 are, in general, pushed by centrifugal force away from the oil's free surface 74 and are, thus, not likely to enter bearing rolling elements 44. This configuration of this embodiment of the invention reduces the likelihood of bearing failure due to lubricant contamination. In this embodiment, bearing chamber 70 contains an oil trajectory adjuster 55 which causes oil 72 to be sprayed into and around bearing assembly 106, including rolling elements 44, to provide lubrication for the moving components and to facilitate heat transfer from the impulse mechanism 36. The wall thickness of lubricating oil 72 is held consistent by oil quantity regulator 56, which removes excess oil and transfers it (via a passageway comprising a bore in spindle 75 and tube transfer pipe 57) to the third chamber of the lubrication system known as the shaft tube chamber 71, which is defined by the space between the two side plates 31 and surrounded by shaft tube 49. The oil 72 from oil quantity regulator 56 is, in this embodiment of the invention, channeled through a hole in spindle 75 and then through tube transfer pipe 57 where it is dropped onto rotating shaft 40, the rotation of which tends to spray the oil out thereby coating the surrounding shaft tube 49. Heat from the oil is transferred to shaft tube 49 and rejected to the surrounding air by means of convection. Shaft tube chamber 71 is in fluid communication with both bearing housings 70. The amount of oil in the lubrication system is such that given an ideal quantity of oil in bearing chambers 70, shaft tube chamber 71 tends to overflow into each bearing chamber, thereby circulating the lubricating oil within the lubrication system.

This embodiment of the invention may be outfitted with a breather valve (not shown) which can be located in any suitable location to provide a means for regulating any pressure differential between the contained impulse mechanism and the atmosphere. One or more drain plugs may also be used to facilitate draining of lubricating oil from the system. An oil sight apparatus may also be used to monitor the oil level as well as provide a means for adding the correct amount of oil during maintenance activities.

Five other configurations which are variations of the preferred embodiment of the invention have been determined by the inventors to be advantageous and will presently be described.

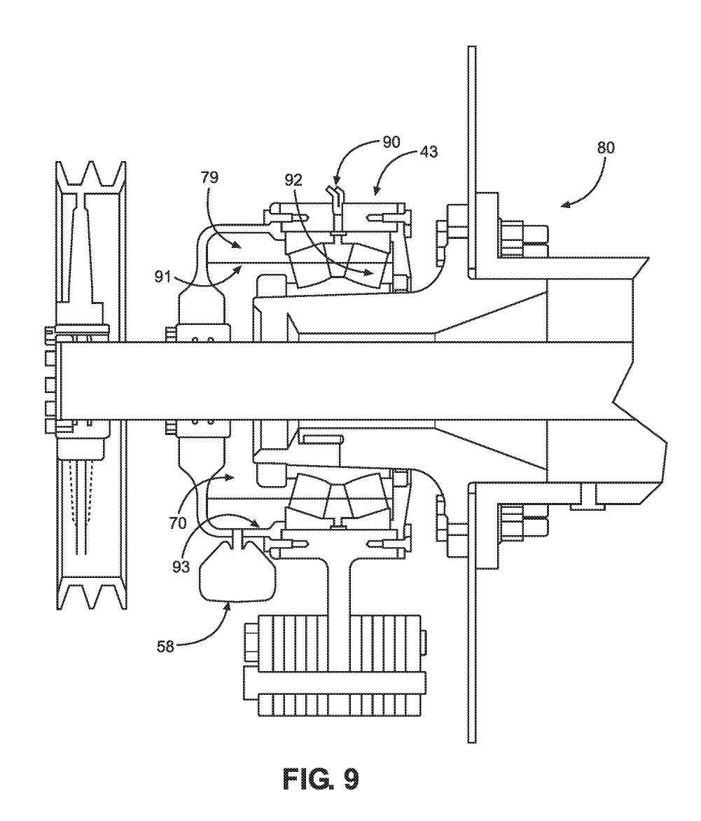

A first alternative embodiment of an impulse mechanism is shown in FIG. 9. This embodiment comprising impulse mechanism 80 is similar to the embodiment shown in FIGS. 4-8, except that certain components, namely oil trajectory adjuster 55, oil quantity regulator 56, tube transfer pipe 57 and bore 75 in the spindle have been removed. In this embodiment, the intended lubricant is grease 79 which may be pumped in through grease fitting 90 which may be located somewhere on eccentric bearing housing 43 or other convenient location. During operation of impulse mechanism 80, the grease would tend to be thrown out to the radial limit of bearing chamber 70, thereby creating a free surface 91 which is similar to free surface 74 of lubricating oil shown in FIG. 7, which is described in the detailed description of the embodiment of FIGS. 4-8. The radial distance (i.e. the distance from the axis of rotation of the shaft) of the free surface is determined by the quantity of lubricant in the chamber and is an important parameter for the impulse mechanism to function properly; the distance must be small enough that grease interacts with rolling elements 92 (i.e. rollers or ball bearings or other rolling elements) of the bearing but also large enough that an excessive amount of grease is not centrifugally forced into the path of the rolling elements, thereby resulting in excess churning which may lead to an unacceptable increase in heat generation. In order to ensure that the proper amount of grease is used during operation, a controlled amount may injected through grease fitting 90. This amount may also be monitored by the use of a bulbous sight glass (not shown) or by removing hub 42 to visually inspect the amount of grease in bearing chamber 70. Contaminants in the bearing chamber 70 would tend to migrate to the outside radial face 93 of the bearing chamber and would then tend to travel (by centrifugal force) to contamination settling chamber 58. Lubricating grease may need to be replaced at scheduled intervals, and this maintenance could be achieved by techniques familiar to those skilled in the art. One approach to replacing the grease that may be advantageous would be to flush the bearing housing with a grease solvent using grease fitting 90 as a solvent inlet and the mounting hole for contamination settling chamber 58 as a solvent outlet. Some who are skilled in the art prefer to add grease at regular intervals instead of replacing all of the grease at once: A method for facilitating this practice (that also preserves the quantity of grease in the system) is to match the amount of grease added to the amount of grease contained in the contamination settling chamber. The grease in the contamination settling chamber would be discarded whenever grease is added and the net grease in the system would be remain substantially unchanged. A grease lubricated impulse mechanism is advantageous since it is relatively easier to seal and may suit the needs of some particular operators who are skilled in the art of screening.

The embodiment shown in FIG. 9 could also be modified to eliminate contamination settling chamber 58 because the viscous grease may trap any contaminants along the outer radial face 93 of the bearing chamber where they would be unlikely to travel to the bearing.

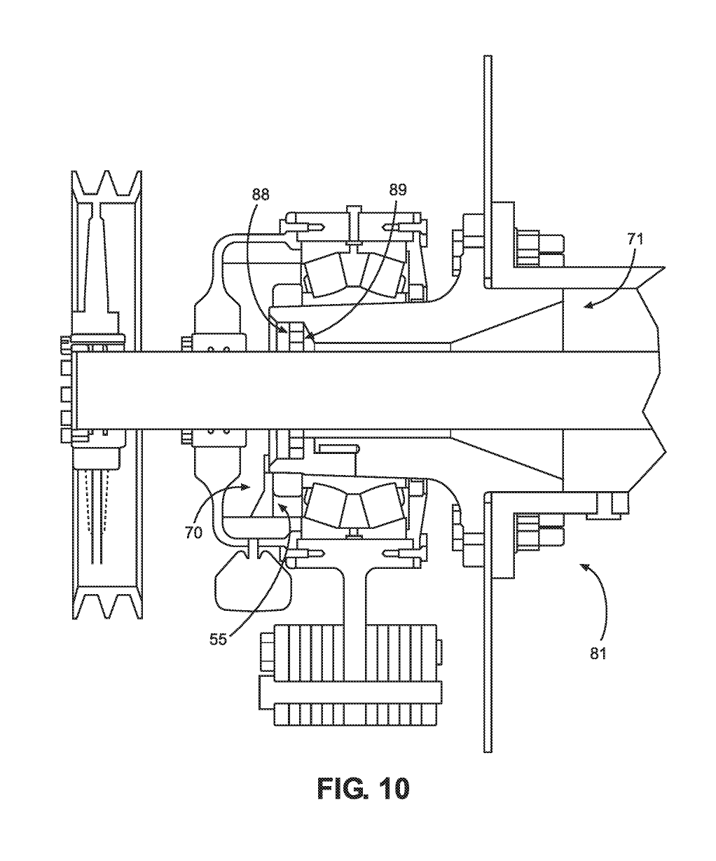

Another embodiment of the invention is shown in FIG. 10. As shown therein, impulse mechanism 81 is similar to the embodiment shown in FIGS. 4-8, except that certain components, namely oil quantity regulator 56, tube transfer pipe 57 and bore 75 in the spindle are removed. In this embodiment, seal housing 88 and seal 89 block lubricating oil from passing from bearing chamber 70 to shaft tube chamber 71. This embodiment of the invention is considered to be advantageous since it reduces the quantity of lubricating oil needed in the system (since no oil would exist in shaft tube chamber 71) and it eliminates contaminants from mingling between bearings.

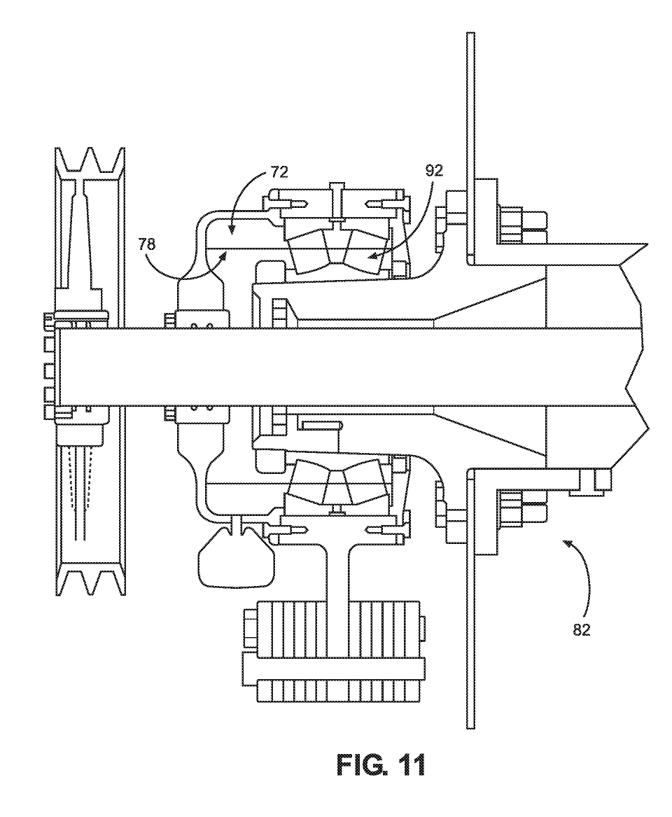

Another embodiment of the invention is shown in FIG. 11. As shown therein, impulse mechanism 82 is similar to impulse mechanism 81 shown in FIG. 10, except that oil trajectory adjuster 55 is eliminated. In this embodiment, the free surface of the oil in bearing chamber 78 would be located so that the rolling elements of bearing 92 are directly exposed to the lubricating oil (i.e. the outer race of the bearing would be completely submerged in lubricating oil during operation). In impulse mechanisms 80, 81, and 82, the location of the free surface of the lubricant in the bearing chamber may be controlled by changing the amount of lubricant in the bearing housing.

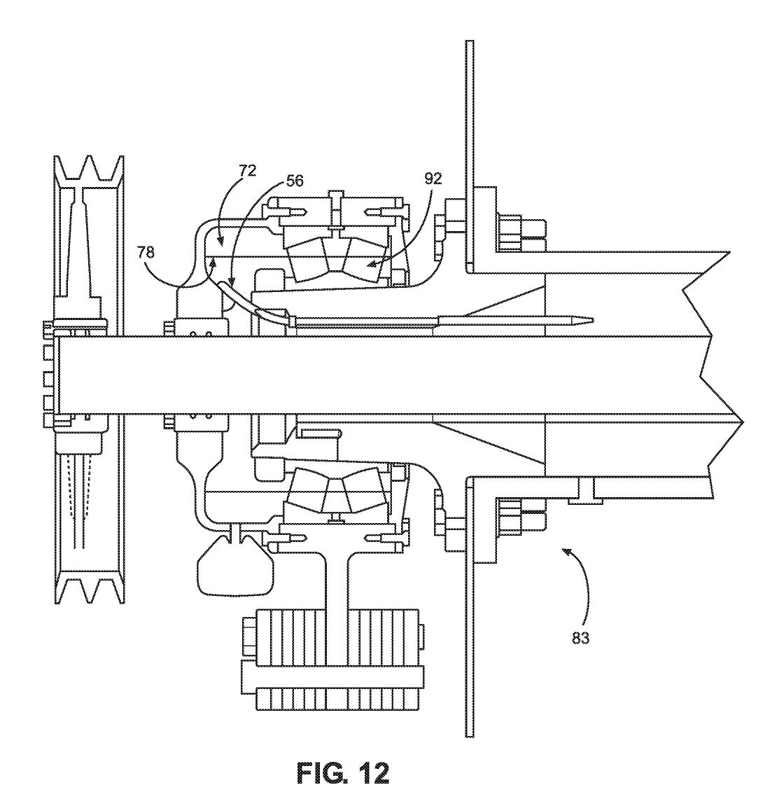

Another embodiment of the invention is shown in FIG. 12. As shown therein, impulse mechanism 83 is similar to the embodiment shown in FIGS. 4-8, except that oil trajectory adjuster 55 is removed and oil quantity regulator 56 is adjusted so that the free surface of the lubricating oil 78 in the bearing chamber is such that the bearing's rolling elements 92 are directly exposed to the oil in the bearing chamber. This embodiment is considered to be advantageous because it does not require an oil trajectory adjuster and may provide appropriate flow of lubricant to the bearing as well as facilitation of adequate heat transfer.

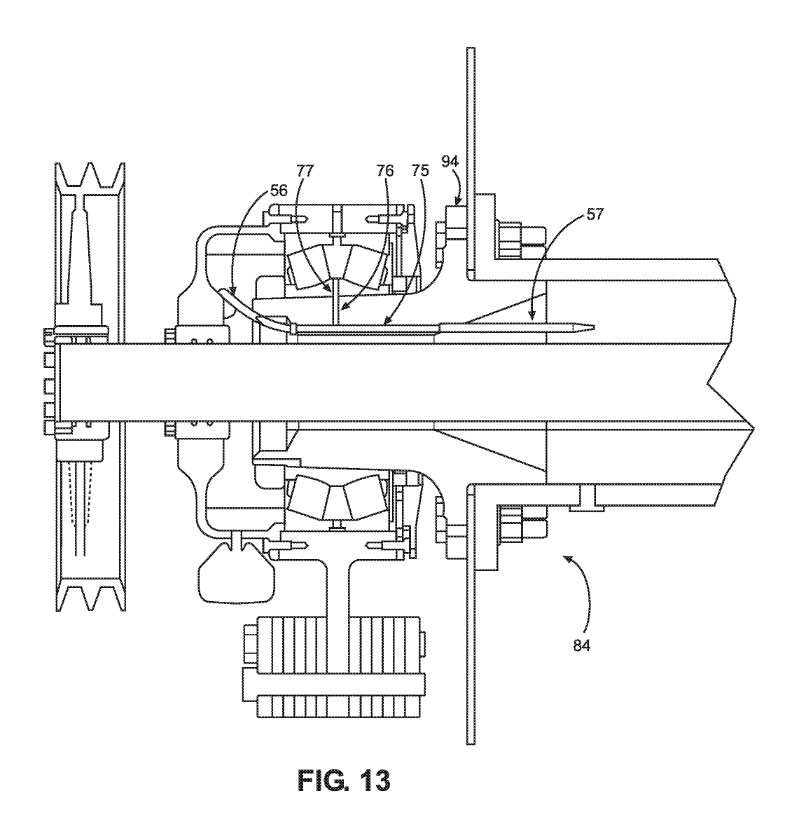

Still another embodiment of the invention is shown in FIG. 13. As shown therein, impulse mechanism 84 is similar to the embodiment shown in FIGS. 4-8, except that oil trajectory adjuster 55 has been removed, and spindle 94 is modified to allow lubricating oil flowing through spindle bore 75 to be diverted to the bearing by means of passageway 76 and an oil groove around the inner race of the bearing and through a hole in the inner race of bearing 77. This embodiment is considered to be advantageous since it does not require an oil trajectory adjuster, and the flow of oil to the bearing may be controlled by changing the diameter of spindle passageway 76 and/or by adjusting the geometry of tube transfer pipe 57 and/or by other changes to the oil passage geometry.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. An impulse mechanism for use with a vibratory screen assembly that includes a pair of parallel side plates that are spaced apart from one another to define a space located between the side plates and that are connected together by one or more screen decks extending laterally across the space and that are oriented perpendicular to the side plates, the impulse mechanism comprising:
a rotatable shaft extending laterally across the vibratory screen assembly and having exposed opposing ends that terminate outside the vibratory screen assembly adjacent each side plate and an axis of rotation running through each opposing end;
a stationary spindle extending outwards from each of the side plates of the vibratory screen assembly and surrounding the opposing ends of the shaft;
a vibration generator located on each of the opposing ends of the shaft that is configured to generate vibrations when the shaft is rotated about the axis of rotation and to transmit those vibrations to the vibratory screen assembly, each vibration generator having:
a bearing housing surrounding, operatively mounted to and rotatable with the shaft;
an exposed mass component mounted to an outer surface of the bearing housing such that it is accessible from outside the bearing housing, the mass component spaced radially outwards from and configured to rotate about the axis of rotation as the shaft rotates in order to generate vibrations; and
a bearing assembly disposed within the bearing housing for rotatably interconnecting the rotatable shaft, bearing housing, and mass component with the stationary spindle and vibratory screen assembly such that vibrations generated by the rotation of the mass component are transmitted through the bearing assembly to the stationary spindle and vibratory screen assembly.

2. The impulse mechanism of claim 1, wherein the vibration generator further comprises:
a hub interconnecting the bearing housing with the shaft; and
a bearing chamber that is at least partially defined by the hub and is in fluid communication with the bearing assembly and is configured to hold a quantity of lubricant and to provide lubricant to the bearing assembly as the shaft rotates.

3. The impulse mechanism of claim 2 further comprising a trajectory adjuster disposed within the bearing chamber and positioned to contact lubricant located within the bearing chamber that is forced radially outwards away from the axis of rotation by centrifugal forces alone against an internal wall of the bearing chamber as the shaft rotates and, as a result of that contact, cause at least a portion of the lubricant to be deposited onto the bearing assembly.

4. The impulse mechanism of claim 2 wherein the hub is removably mounted over a first open side of the bearing housing.

5. The impulse mechanism of claim 4 further comprising:
a first seal housing that is removably mounted over a second open side of the bearing housing that is located opposite the first open side, the first seal housing having a central opening that slides over and surrounds the spindle; and
a first seal provided in the central opening of the first seal housing for surrounding and interacting with the spindle to contain the lubricant within the bearing chamber and to prevent external contaminants from entering the bearing chamber.

6. The impulse mechanism of claim 5 further comprising:
a second seal housing that is located within the bearing chamber and that surrounds and is removably mounted to a distal end of the spindle, the second seal housing having a central opening that slides over and surrounds the shaft; and
a second seal provided in the central opening of the second seal housing for surrounding and interacting with the shaft to contain the lubricant within the bearing chamber and to prevent external contaminants from entering the bearing chamber.

7. The impulse mechanism of claim 2 further comprising a contamination settling chamber that is mounted externally to the bearing chamber and that has an inlet that is in fluid communication with the bearing chamber, wherein, when the shaft rotates the bearing chamber, lubricant located within the bearing chamber is forced radially outwards away from the axis of rotation by centrifugal forces alone and against an internal wall of the bearing chamber where the inlet of the contamination settling chamber is located such that impurities that are more dense than the lubricant and that are located within the lubricant are forced radially outwards to the internal wall of the bearing chamber, through the inlet, and into the contamination settling chamber.

8. The impulse mechanism of claim 1 further comprising a hollow shaft tube enclosing a portion of the shaft extending between the side plates of the vibratory screen assembly.

9. The impulse mechanism of claim 8 further comprising a plurality of fasteners passing through portions of the stationary spindle that are in contact with an outside surface of the side plates, through the side plate, and through portions of the hollow shaft tube that are in contact with an inside surface of the side plate in order to sandwich the side plate between an the hollow shaft tube and the stationary spindle.

10. The impulse mechanism of claim 8 further comprising:
a hub interconnecting the bearing housing with the shaft;
a bearing chamber that is at least partially defined by the hub and is in fluid communication with the bearing assembly and is configured to hold a quantity of lubricant and to provide lubricant to the bearing assembly as the shaft rotates;
a shaft tube chamber formed between an interior radial wall surface of the shaft tube and the shaft; and
a passageway extending from the bearing chamber to the shaft tube chamber that is configured to carry lubricant from the bearing chamber to the shaft tube chamber and from the shaft tube chamber to the bearing chamber.

11. The impulse mechanism of claim 10, wherein the passageway further comprises:
a first bore that extends at least partially through the spindle;
a first transfer pipe having one end that is in fluid communication with a first end of the first bore and opposite end that is in fluid communication with the bearing chamber; and
a second transfer pipe having one end that is in fluid communication with a second end of the first bore and opposite end that is in fluid communication with the shaft tube chamber.

12. The impulse mechanism of claim 11 further comprising a second bore connecting the first bore to the bearing assembly for carrying lubricant passing through the first bore directly to the bearing assembly.

13. The impulse mechanism of claim 1 wherein the bearing assembly comprises:
a stationary bearing inner race surrounding an outside portion of the stationary spindle;
a bearing outer race rotatable with the bearing housing; and
a plurality of rolling elements in rolling contact with both the bearing inner race and the bearing outer race to enable the bearing outer race to rotate around the stationary bearing inner race.

14. The impulse mechanism of claim 13 further comprising:
a hub interconnecting the bearing housing with the shaft;
a bearing chamber that is at least partially defined by the hub and bearing housing and is in fluid communication with the bearing assembly and is configured to hold a quantity of lubricating oil and to provide lubricating oil to the bearing assembly as the shaft rotates;
a quantity of lubricating oil located in the bearing chamber that, when the impulse mechanism is rotating at a normal operating speed, is deposited on an inner surface of the bearing chamber and has a depth that extends radially inwards from the inner surface of the bearing chamber towards the axis of rotation of the impulse mechanism up to a free surface, wherein the free surface of lubricating oil is located such that the rolling elements are not directly exposed to the lubricating oil; and
a trajectory adjuster disposed within the bearing chamber and positioned to contact the lubricating oil and, as a result of that contact, to cause at least a portion of the lubricating oil to be sprayed onto the rolling elements.

15. The impulse mechanism of claim 13 further comprising:
a hub interconnecting the bearing housing with the shaft;
a bearing chamber that is at least partially defined by the hub and bearing housing and is in fluid communication with the bearing assembly and is configured to hold a quantity of lubricating oil and to provide lubricating oil to the bearing assembly as the shaft rotates;
a quantity of lubricating oil located in the bearing chamber that, when the impulse mechanism is rotating at a normal operating speed, is deposited on an inner surface of the bearing chamber and has a depth that extends radially inwards from the inner surface of the bearing chamber towards the axis of rotation of the impulse mechanism up to a free surface, wherein the free surface of lubricating oil is located such that the rolling elements are directly exposed to the lubricating oil.

16. The impulse mechanism of claim 1 further comprising a grease fitting formed in the bearing housing for injecting grease directly into the bearing assembly.
